(19) United States
(12) Patent Application Publication
(10) Pub. No.: US 2008/0030781 A1
(43) Pub. Date: Feb. 7, 2008

(54) Output control server and data output system

(75) Inventors: Tomohiro Iwase, Tokyo (JP); Tomoyuki Ishii, Tokyo (JP); Akemi Morita, Tokyo (JP); Daiki Nishioka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/600,171

(22) Filed: Nov. 16, 2006

(30) Foreign Application Priority Data
Aug. 7, 2006 (JP) JP2006-215058

(51) Int. Cl. G06K 15/00

(52) U.S. Cl. 358/1.16

(57) ABSTRACT

After receiving job data from an information processing terminal, job data wherein an output device is designated as an output destination, a server preserves therein the job data until the moment when an output processing for the job data becomes practicable on the device of the output destination, then, creates second job data representing a replication of the job data before the transfer of the job data to the output device is started, and it conducts changing process for the second job data representing a replication, when it receives an instruction for changing an output destination and output setting, after the transfer. Further, the job data are preserved in the output control server until the moment when the print processing is completed at the output destination, so that they may cope with changing operations for a period up to completion of printing.

This application is based on Japanese Patent Application No. 2006-215058 filed on Aug. 7, 2006 in Japanese Patent Office, the entire content of which is hereby incorporated by reference.

### BACKGROUND OF THE INVENTION

The present invention relates to a data output system that conducts transfer of data from an information processing terminal to an output device through an output control server that is connected to a network, and to the output control server.

When printing data are transmitted from an information processing terminal such as a personal computer to a printer for printing, troubles of some kind are sometimes caused during printing in the printer, and there have been proposed various technologies to lighten users' burdens to transmit the printing data again for taking actions for the troubles.

For example, there has been disclosed an image forming system wherein, when a trouble is caused in the course of processing a printing job in a printing device, the job in which the trouble has been caused can be printed uninterruptedly, without forcing complicated operations upon a user, by making a replication of a spool preserved temporarily on the host computer side in a nonvolatile memory, and by transferring again the replicated spool in the nonvolatile memory after the printing device is restored (for example, see Patent Document 1).

### (Patent Document 1)

### Unexamined Japanese Patent Application Publication No. 2002-196916

In the aforesaid technology, the print job wherein a trouble was caused can be practiced again on the same printing device. However, when a trouble of the printing device cannot be restored promptly, a user wishes to change an output destination to another printing device. However, since the job has already been transmitted to an output device and is in a condition of waiting for output in the output device, the user is required to delete the job once from the present output device, and to input the same job again in the other output device, for changing an output destination, which has compelled complicated operations on a user.

In circumstances wherein an output device such as a printer or a copying machine connected to a network such as LAN (Local Area Network) in the place of business is shared by information processing terminals of many users connected to the aforesaid network, there is an occasion wherein a print server is provided on the network and printing data coming from information processing terminals are transferred to output devices through the print server.

Since the print server of this kind is usually arranged so that printing data are deleted from the server simultaneously with completion of transfer of the printing data to the output device, when a change of an output destination is desired after completion of the transfer, a user is required to specify the printing file again and to establish various types of output setting, for inputting print job, which has been time-consuming.

Further, as shown in FIG. 18, when transfer time tB for job B representing a succeeding job following job A to transfer from a server to an output device is extremely long compared with print processing time tP for job A representing a preceding job, job B still is in the state of transfer even at a point of time of completion of printing for job A. In this case, even when a user desires to change output setting of printing concerning job B, or to change an output destination to another output device, it has been impossible to change output setting and an output destination for job B in the state of data transfer.

Further, as shown in FIG. 19, when a trouble such as a jam is caused abnormally on the output device under outputting job A representing a preceding job while job B representing a succeeding job is being transferred, output processing is stopped accordingly. The server causes job B to wait for being transferred on its half way until the output device is restored, although a change of an output destination is sometimes desired. In this case, it is impossible to change output setting for job B and to change an output destination while the transfer is caused to wait, even though a change of an output destination is sometimes desired, which has been putting users under severe stress.

### SUMMARY

The invention is one to solve the aforesaid problems, and its objective is to provide an output control server and a data output system, which can change an output destination and output setting for the job whose transfer has already been started and the job whose transfer has been completed.

The points of the invention to achieve the aforesaid objective are contained in the following items of the invention.

[1]

An output control server connected with an information processing terminal and with an output device through a network, having therein communication section “A” that receives job data to be processed by the output device from the aforesaid information processing terminal, a memory that keeps the job data received by the communication section “A” and a control section that controls the job data and controls transmitting and receiving of the job data, wherein the control section controls to transfer the job data held in the memory to the output device and deletes the job data from the memory when the transfer is completed and controls to create second job data representing a replication of the aforesaid job data to keep them in the memory when transferring the job data.

[2]

A data output system in which an information processing terminal, plural output devices and an output control server are connected through a network, wherein the information processing terminal has communication section “C” that transmits job data to be processed by the output device to the output control server, and the output device has communication section “B” that transmits a completion notice for the output processing to the output control server when output processing concerning the job data transferred from the output control server has been completed, and wherein the output control server is provided with communication section “A” that receives, from the information processing terminal, job data to be processed by the output device, and with a memory holding the job data received by the communication section “A”, and with a control section that controls the job data as well as transmitting and receiving of the job data, and the control section conducts the control to transfer the job data held by the memory to the output device, and to delete the job data from the memory when the transfer is completed and the control to create second job data representing a replication of the aforesaid job data when transferring the job data, and to cause them to be held by the aforesaid memory.

In the aforesaid inventions of [1] and [2], before the transfer of the job data to the output device is started, the second job data representing replications of the job data are created and are held, in the output control server. Owing to this, it is possible to use the second job data thus duplicated in place of the job data which are in course of the transfer, and thereby to cope with changes of an output destination and of output setting, even in the case where the transfer of the job data is started and changes in the job data become impossible.

[3]

An output control server in which an information processing terminal and an output device are connected through a network, wherein there are provided communication section “A” that receives, from the information processing terminal, job data to be processed by the output device, a memory that stores the job data received by the communication section “A” and a control section that controls the job data as well as transmitting and receiving of the job data, and the control section controls to transfer the job data held by the memory to the output device, then, to hold the job data in the memory until the moment when a notice of output completion is received from the output device, and to delete the job data from the memory when the notice of the output completion is received from the output device.

[4]

A data output system in which an information processing terminal, plural output devices and an output control server are connected through a network, wherein the information processing terminal has communication section “C” that transmits job data to be processed by the output device to the output control server, and the output control server is provided with communication section “A” that receives the job data from the information processing terminal, and with a memory that holds the job data received by the communication section “A”, and with a control section that controls the job data as well as transmitting and receiving of the job data, and wherein the control section controls to transfer the job data held by the memory to the output device, then, to hold the job data in the memory until the moment when a notice of output completion is received from the output device, and to delete the job data from the memory when the notice of the output completion is received from the output device.

In the aforesaid inventions of [3] and [4], job data received from the information processing terminal are not deleted from the output control server at the stage where the transfer to the output device has been completed, and they are held until the moment when a notice of completion of output processing is received from the output device. Due to this, it is possible to change an output destination and output setting for the job by processing for the job data held in the output control server, without receiving re-transmitted job data from the information processing terminal, even after completion of the transfer, if the output processing is not yet completed.

### BRIEF DESCRIPTION OF THE DRAWINGS

FIG. 1 is an illustration showing an example of the structure of a data output system relating to an embodiment of the invention.

FIG. 2 is a block diagram showing the primary functional structure of a data output system relating to the first embodiment of the invention.

FIG. 3 is an illustration showing a data structure in a memory of an output control server relating to an embodiment of the invention.

FIG. 4 is an illustration showing an example of an output operation screen that is displayed on a display device of an information processing terminal when printing is instructed from the information processing terminal.

FIG. 5 is an illustration showing an active job list.

FIG. 6 is an illustration showing an example of the output operation screen in the case of changing an output destination.

FIG. 7 is an illustration showing progress of data relating to the output instruction.

FIG. 8 is a sequence diagram showing progress of data relating to the output instruction.

FIG. 9 is a sequence diagram showing progress of data relating to the output change instruction.

FIG. 10 is an illustration showing the state of registered data in a memory before the job movement and that after the job movement by comparing them.

FIG. 11 is a flow chart showing processing procedures of the output control server relating to the first embodiment.

FIG. 12 is an illustration showing operations of the output control server and the first output device “a” in ordinary operations in the case of completing printing in the output destination instructed first.

FIG. 13 is an illustration showing operations on the occasion where manipulations to change output destination were made in the course of the transfer of the job data.

FIG. 14 is an illustration showing operations on the occasion where manipulations to change output setting were made in the course of the transfer of the job data.

FIG. 15 is an illustration showing operations in the case of receiving from a user, the instruction to change an output destination, after completing the transfer of the job data normally to the output device.

FIG. 16 is a sequence diagram showing progress of data in the case of changing an output destination and output setting.

FIG. 17 is a flow chart showing processing procedures of an output control server relating to the second embodiment.

FIG. 18 is an illustration showing data progress in the case of the occasion where the transfer of data relating to succeeding job B is continued even after completion of printing for preceding job A, in accordance with the passage of time.

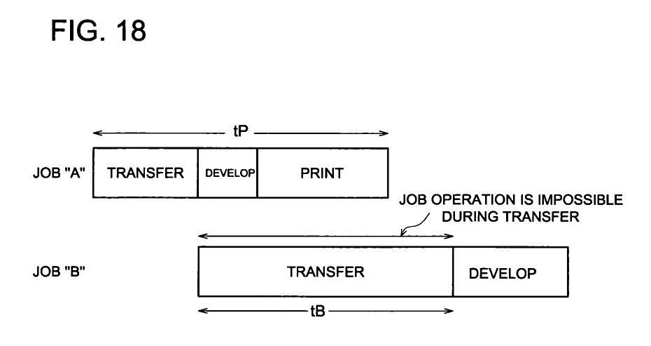

FIG. 19 is an illustration showing data progress in the case wherein a trouble is caused in the course of processing of preceding job A while succeeding job B is transferred, and data transfer for the succeeding job B turns out to be in the standby state, in accordance with the passage of time.

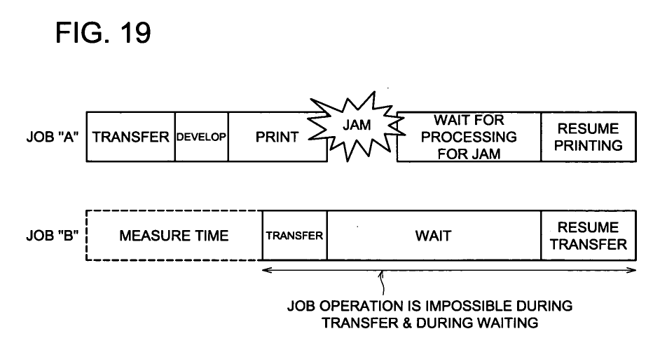

### DETAILED DESCRIPTION OF THE PREFERRED EMBODIMENT

Various types of embodiments of the invention will be explained as follows, referring to the drawings.

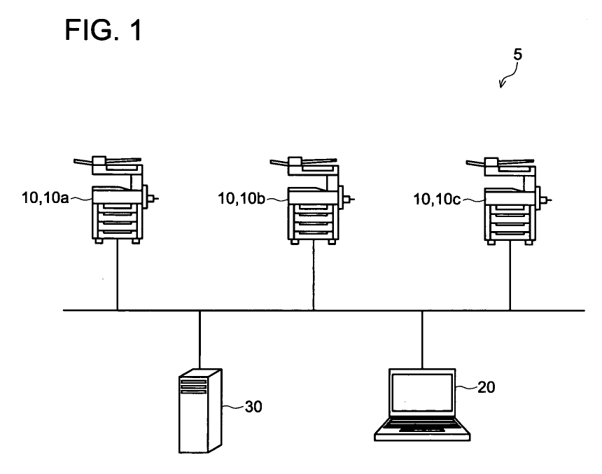

FIG. 1 shows an example of the structure of data output system 5 relating to an embodiment of the invention. The data output system 5 is composed of a plurality of output devices 10, information processing terminal 20 and output control server 30 which are connected through network 2 such as LAN.

The output device 10 is a device conducting output processing (including also box storage) relating to image data such as a printer, a facsimile machine and a multifunctional machine. In the example shown in FIG. 1, the output device 10 is represented by the so-called digital multifunctional machine (MFP) equipped with plural functions such as a printer function, a scanner function and a facsimile function. The information processing terminal 20 is composed of a personal computer or the like, and is an information processing device equipped with a function to transmit job data for causing output device 10 to practice the job for printing and facsimile transmission, to the outer terminal, and to request implementation of output processing. Output control server 30 is a server which is provided with a communication function and an accumulating function. Though only one set of information processing terminal 20 is shown in FIG. 1, plural sets may also be arranged. Though the first, second and third output devices 10a, 10b and 10c are illustrated as the output device 10, the number of the devices may be any plural number.

In the data output system 5, output control server 30 receives job data transmitted from information processing terminal 20, then, maintains the job data in itself until the moment when the job relating to the job data becomes practicable in output device 10 designated as an output destination, and conducts the control for synchronizing with transfer timing at which the output device 10 designated as an output destination becomes practicable for the job. Owing to this, the transfer of the job data is started in accordance with the timing at which a device of an output destination becomes capable of processing output, therefore, the timing of starting the transfer can be delayed, and by just that much, a possibility that operations for changing an output destination and output setting are conducted before the start of transfer of the data, is enhanced, and processing for operations for changes becomes easy. Incidentally, the moment when the job becomes practicable may either be notified to the output control device from the output device or be estimated on the output control server side based on an amount of data or the processing amount of the output device side. Further, in the course of transferring job data from output control server 30 to output device 10, or even for the period of time until the moment when output processing is completed in the output device after completion of the transfer, an instruction for changing an output destination of the job relating to the aforesaid job data and an instruction for changing output setting are received.

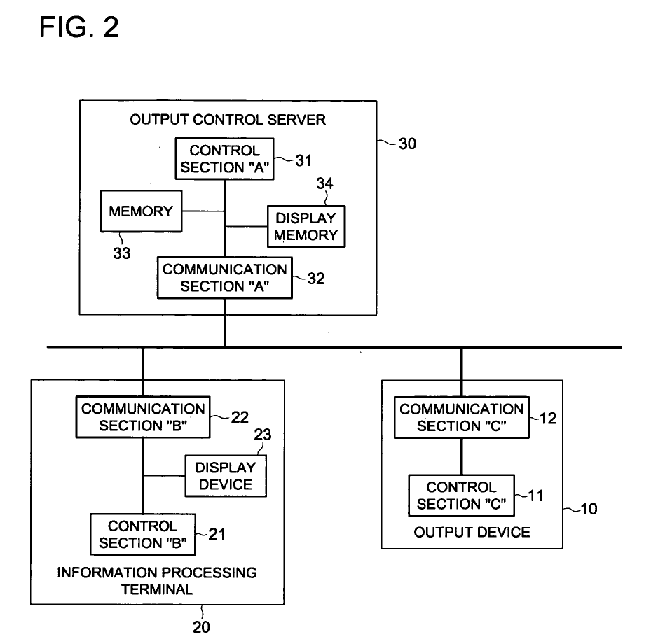

FIG. 2 shows the primary functional structures of a data output system 5. Output control server 30 is equipped with control section A 31, third communication section A 32, memory 33 and display memory 34. Further, information processing terminal 20 is equipped with control section B 21, second communication section B 22 and display device 23. Output device 10 is equipped with control section C 11 and first communication section C 12.

Each of control section A, control section B and control section C is composed of CPU (Central Processing Unit), ROM (Read Only Memory) and RAM (Random Access Memory). Further, output device 10 is equipped with a printer section, a facsimile control section, a scanner section and a data storage section.

Control section B 21 of information processing terminal 20 conducts the control to transmit job data to output control server 30. Job data are composed of data to be outputted such as document text data and graphics data, setting data such as setting information concerning job type (printing and facsimile transmission) and output, and information of an output destination for designating a device of an output destination (for example, IP address of a device of an output destination).

Communication section A 32 of output control server 30 has a function to receive job data from information processing terminal 20. Memory 33 holds job data received by the communication section A 32 by correlating them with output device 10 designated as an output destination. The memory 33 is composed, for example, of a hard disc device, and it stores data.

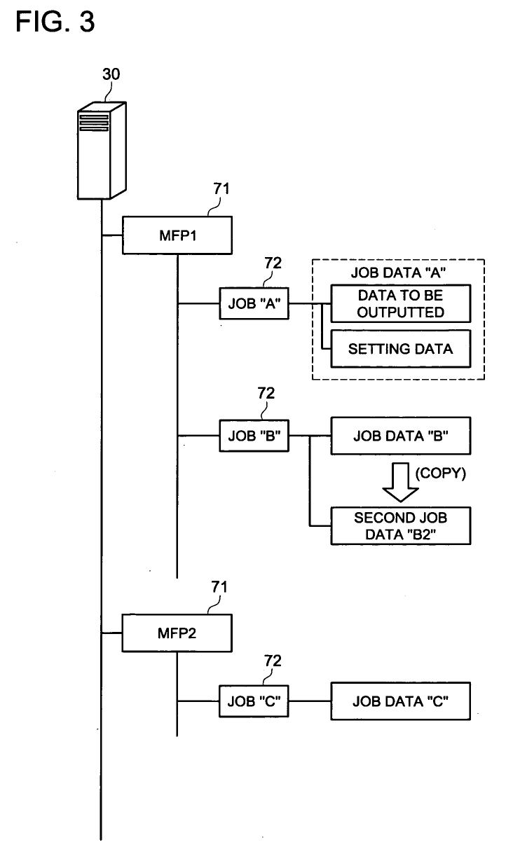

FIG. 3 shows a data structure in memory 33 of output control server 30. In the memory 33, there is generated output destination folder 71 representing a folder corresponding to each output device 10 connected to the data output system 5, and in the output destination folder 71, there is created job holder 72 for each job for which the output device 10 corresponding to the output destination folder 71 is designated as an output destination. The output destination folder 71 is created under a folder name including a name of the corresponding output device 10 (MFP1 or MFP2) and IP (Internet Protocol) address. With respect to the output destination folder 71, when certain output device 10 is connected to the data output system 5 first, for example, output destination folder 71 corresponding to that output device 10 is automatically generated.

In each job folder 72, there are preserved job data for that job (set data and data to be outputted). By preserving job data in job folder 72 created in the output destination folder 71 corresponding to output device 10, a job relating the job data is correlated with output device 10 which is an output destination for the job.

The explanation will be continued by returning to FIG. 2. Control section A 31 of output control server 30 reserves output of job based on the job data, for output device 10 that is designated as an output destination for the job data held in memory 33. Control section C 11 of output device 10 receives output reservation from output control server 30, and conducts internal registration of a job on a reservation queue. It further conducts the control of output reservation that requests output control server 30 to send job data concerning a job when processing for the job reserved in terms of output becomes practicable.

The control section A 31 determines timing when processing for the job becomes practicable in output device 10 representing an output destination for the job for each job reserved for output whose job data are retained in memory 33, and controls transfer of job data of each job in memory 33, in accordance with the timing when processing for the job becomes practicable.

Further, the control section A 31 creates, before the start of transfer of job data, the file of second job data representing a replication of the job data, and causes them to be preserved in output destination folder 71 which is the same as that for the original job data. In the example shown in FIG. 3, second job data B2 is created as a replication of job data B. Owing to this, the timing for creating the second job data B2 is delayed to the necessary timing, and a storage area of the memory can be utilized effectively. Though second job data B2 are replicated in the same job folder as that for job data B in this case, a replication may also be created for each job holder of job B.

Control section B 21 of information processing terminal 20 controls to transmit, to output control server 30, an instruction for changing output destinations for job data held in memory 33 of output control server 30 and an instruction for changing output setting.

Communication section A 32 of output control server 30 receives an instruction for changing output destinations and an instruction for changing output setting from information processing terminal 20. Communication section A 31 conducts processing for changing output destinations of job data based on the instruction for changing output destinations received by the communication section A 32. Further, when an instruction for changing output destinations for the job data is received in the course of transferring job data, processing for changing output destinations is conducted for the second job data representing a replication of that job data.

Control section A 31 conducts processing of change concerning output setting of job data, based on an instruction for changing output setting received by communication section A 32. The output setting includes, for example, two-sided printing/single side printing, number of prints, sheet size and margins in outputting (printing). When an instruction for changing output setting for the job data is received during the transfer of the job data, the
communication section A 32 is supposed to conduct processing for changing output setting for the second job data representing a replication of that job data.

If the communication section A 32 receives, from output device 10, a notice of completion of output processing, job data (job files) held in memory 33 are deleted in control section A 31.

Further, the control section A 31 conducts control of display for causing information processing terminal 20 to display an operation screen for giving an instruction for outputting a job. Display memory 34 stores layout information (like map information) concerning a place of installation of output device 10. The control section A 31 is supposed to generate display data of an operation screen to be displayed by information processing terminal 20 in accordance with layout information stored in display memory 34 and conditions of holding job data on memory 33.

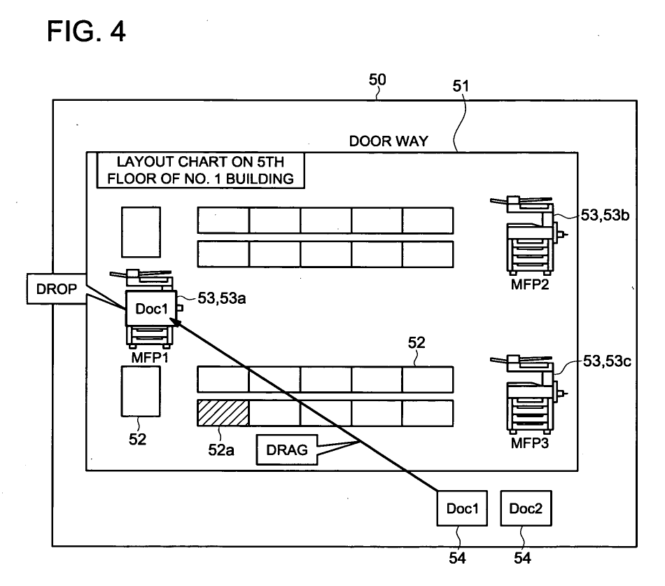

FIG. 4 shows an example of output operation screen 50 that is displayed on display device 23 of information processing terminal 20 when printing of a document is instructed from the information processing terminal 20. The output operation screen 50 is one on which a web page offered by control section A 31 of output control server 30 is displayed by utilizing a browser function of the information processing terminal 20.

Layout image 51 for indicating an arrangement of respective output devices 10a, 10b and 10c is displayed on output operation screen 50. On the layout image 51, there are displayed objects such as desk 52 and others installed on a floor, in accordance with an actual arrangement, and there are displayed device icons 53 corresponding to output devices 10 at positions according to installation positions for actual output devices 10a, 10b and 10C.

ID information (machine numbers such as MFP1 and MFP2, in this case) of corresponding output devices 10 are marked on each device icon 53. In FIG. 4, first output device 10a shown in FIG. 1 corresponds to device icon 53a, second output device 10b corresponds to device icon 53b and third output device 10c corresponds to device icon 53c. Owing to this, a user can give an output instruction and an instruction for changing output destinations, while confirming an arrangement of each output device on the layout image, which improves operationality and user-friendliness.

On output operation screen 50, there is further displayed data icon 54 representing an icon corresponding to a data file capable of outputting. On the data icon 54, there is added and displayed a file name of a data file (Doc 1 in the figure, or the like). Further, a position of information processing terminal 20 (hatched desk 52a in the figure), indicating this output operation screen 50 is also indicated clearly.

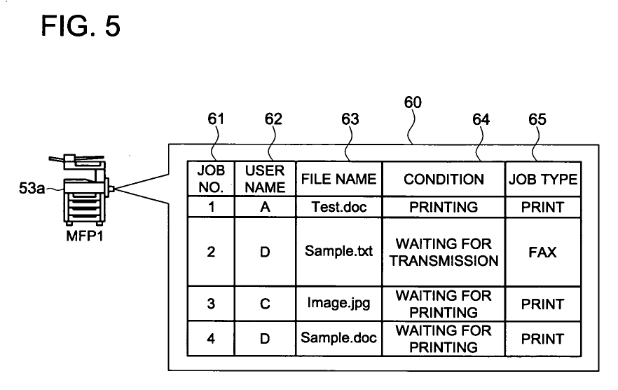

When a user clicks device icon 53 on layout image 51, or drags any data icon 54 onto the device icon 53, active job list 60 concerning output device 10 corresponding to the device icon 53 is displayed in a pop-up way as shown in FIG. 5. The active job list 60 is one wherein information concerning jobs which are inputted while the output device 10 is designated as an output destination, and are staying under the condition that output is noncompletion, is displayed as a list, and job number 61, user name 62, file name 63, situation (in process of printing or in process of waiting) 64 and job type 65 are displayed for each job.

In information processing terminal 20, if data icon 54 is dragged to device icon 53 to be dropped, by using a mouse (pointing device), a print instruction (output instruction) by which a data file corresponding to the data icon 54 is printed by output device 10 corresponding to the device icon 53 is sent to output control server 30 from the information processing terminal 20. This looks for a user as if a job is transmitted actually to an output device through the drag & drop operations. Due to this, the user can carry out easily an output instruction and an instruction for changing output destinations, through the user interface such as drag & drop on the operation screen provided from the output control server to the information processing terminal.

Further, when the active job-list 60 is displayed by the aforesaid operations after outputting a print instruction, if the job is selected from the displayed jobs, a setting screen is displayed so that output setting for the selected job can be changed. If the output setting is changed, an instruction for changing output setting showing the contents of the changes is sent to output control server 30 from information processing terminal 20.

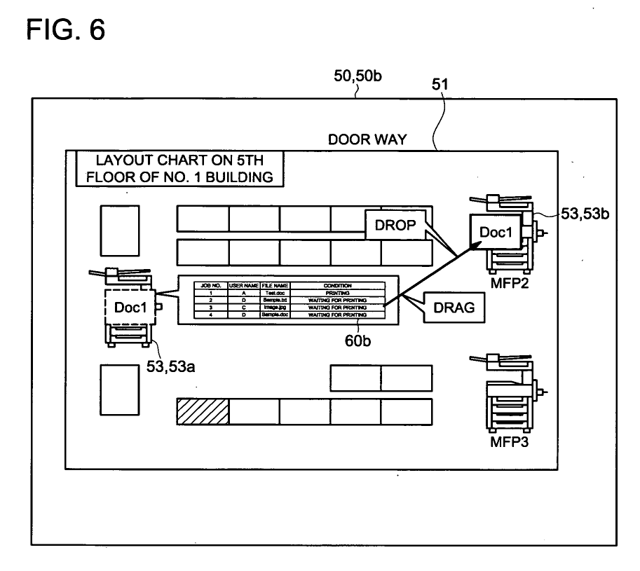

It is further possible to change output destinations through the drag & drop operations shown on output operation screen 50b in FIG. 6, after outputting a print instruction. That is, when device icon 53a on layout image 51 is clicked to display active job list 60b of the output device 10a, and if the targeted job is selected from the job list to be dragged & dropped on other device icon 53b, an instruction for changing the output destination of that job to output device 10b corresponding to device icon 53b on the drop destination is transmitted to the output control server 30. In the example shown in FIG. 6, an output job of “Doc 1” is moved from the first output device 10a to the second output device 10b, by dragging & dropping data icon 54a onto device icon 53b.

Next, internal control on the occasion where an instruction for output is sent to output device 10 from information processing terminal 20, will be explained.

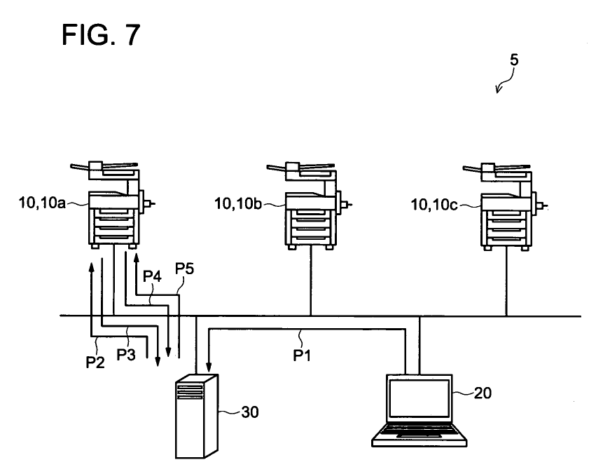

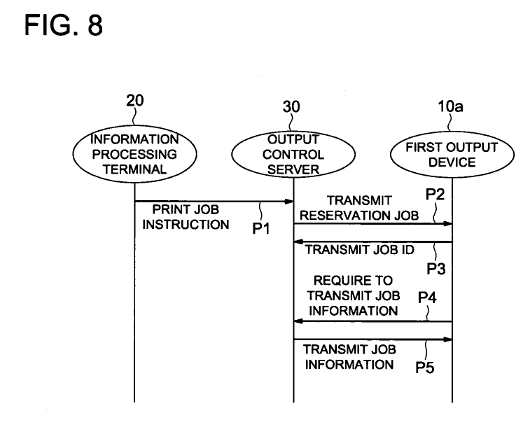

FIG. 7 is one showing, by using a system configuration diagram, the progress of data in the aforesaid internal control. FIG. 8 is one on which the progress of data is expressed on a sequence basis. In FIG. 7 and FIG. 8, respective processes each being given a symbol of each of P1-P4 correspond each other in both drawings. Incidentally, in this case, it is assumed that the first output device 10a is designated as an output destination.

First, job data corresponding to an instruction for output generated by an operation method shown in FIG. 4 are transmitted to output control server 30 from information processing terminal 20 (P1). The output control server 30 holds job data received from the information processing terminal 20 in output destination folder 71a corresponding to output device 10a designated as an output destination, as a job file.

The output control server 30 further acquires a job type and IP address of information processing terminal 20 representing a source of transmission, from job data received from the information processing terminal 20, and conducts output reservation by transmitting reservation job information (information showing IP address and a job type) to the first output device 10a designated as an output destination (P2). The first output device 10a which has received the reservation job information registers a job as an active job with functions (printing, facsimile transmission and box storage) corresponding to the job type.

The first output device 10a gives job ID to the job in the case of registering the job, and sends back the job ID to output control server 30 (P3). The output control server 30 that has received the job ID registers this job ID by correlating it with job data of the job for which the reservation job information is issued (for example, in a file where job data are housed).

The first output device 10a transmits the request for sending job information including job ID of the job to output control server 30, when any one job among those registered as active jobs becomes practicable newly. Owing to this, the output control server 30 is requested to send job data of the job (P4). For example, when implementation of the preceding print job is completed, the print job whose order in terms of reservation is next becomes practicable, and a request for sending data relating to the print job (request to send job information) is transmitted to the output control server 30.

After receiving the request for sending job information from the first output device 10a, the output control server 30 retrieves job data correlated with job ID identical to job ID included in this request for sending job information in output destination folder 71a corresponding to the first output device 10a, and transmits the job data to the first output device 10a (P5).

Output device 10 which has received the transfer of job data from output control server 30 carries out the job such as print processing, following the job data thus received.

Next, there will be explained operations in the case of moving the job from the first output device 10a to the second output device 10b before the start of the transfer of job data.

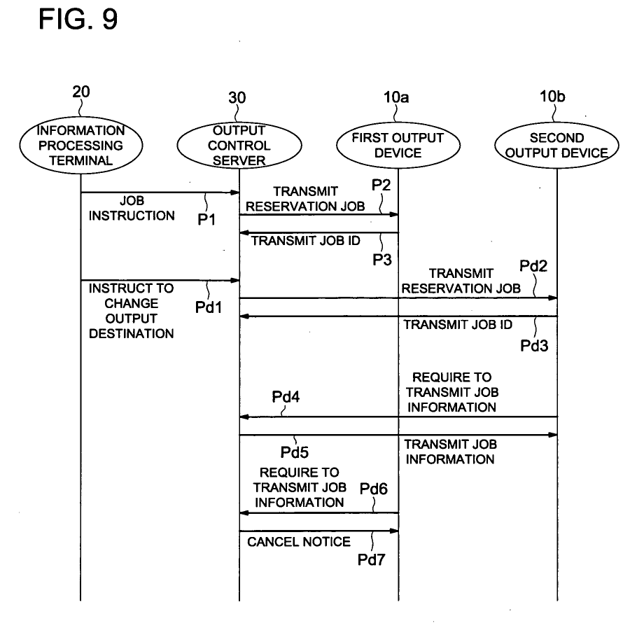

FIG. 9 is a sequence diagram showing progress of data in the case of changing the output destination of the job to the second output device 10b, before the start of the transfer of the job data to the first output device 10a from output control server 30, after transmitting, from information processing terminal 20, an output instruction designating the first output device 10a as an output destination. Processes represented by P1-P3 in the figure are the same as those shown in FIG. 8, and explanations for them will be omitted accordingly.

After operations for changing output destinations are carried out through drag & drop operations shown in FIG. 6, an instruction for changing output destinations showing the contents of changes is transmitted from the information processing terminal 20 to output control server 30 (Pd1). The instruction for changing output destinations includes job ID and ID addresses before and after the changes.

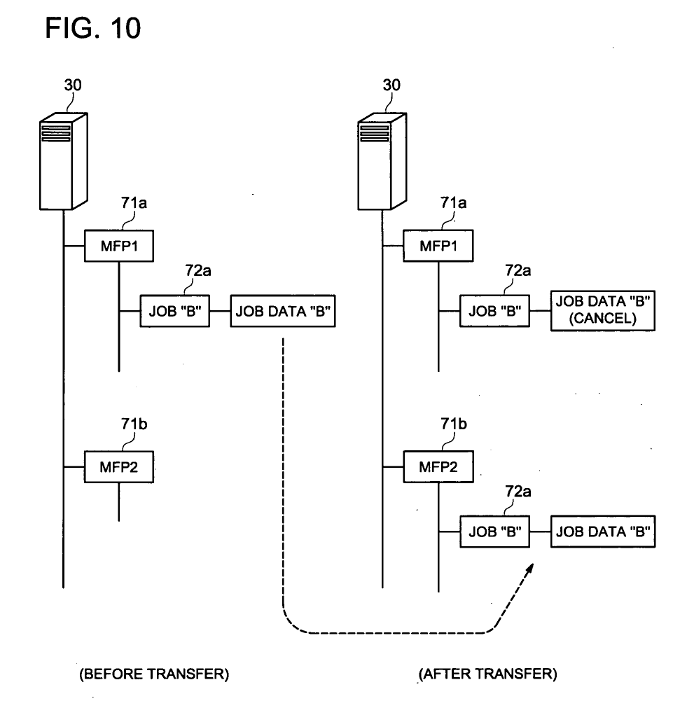

The output control server 30 which has received the instruction for changing output destinations newly creates job folder 72b for the job in output destination folder 71b corresponding to output device 10b after the change, as shown in FIG. 10, and replicates job data B of job B to be moved to this job folder 72b (setting data and data to be outputted). Further, the state information of the job registered in job folder 72a representing a source is changed to “Cancel”.

After that, in the same way as in the case of output instruction, reservation job information (information showing an IP address and a job type) is transmitted to the second output device 10b to conduct output reservation (FIG. 9, Pd2), and job ID sent back from the second output device 10b is registered in the corresponding job folder 72b (Pd3).

After receiving a request for sending job information concerning job B from the second output device 10b (FIG. 9, Pd4), the output control server 30 transfers job data B (setting data and data to be outputted) preserved in the corresponding job folder 72b to the second output device 10b (Pd5).

On the other hand, after receiving a request for sending job information for job B from the first output device 10a representing an output destination before the change (Pd6), the output control server 30 erases and eliminates job data B preserved in job folder 72a and the job folder 72a itself from memory 33, because the state information of the job is “Cancel” on the corresponding job folder 72a (see “AFTER TRANSFER” in FIG. 10). Further, a notice of cancel for the job is transmitted to the first output device 10a (FIG. 9, Pd7).

The first output device 10a which has received the notice of cancel carries out cancel processing concerning the job corresponding to the aforesaid request for sending job information, and moves to the succeeding job processing. For example, the cancel processing at the first output device 10a includes a change in a history of a list of active jobs.

Since the job data (setting data and data to be outputted) are held in memory 33 of output control server 30 until the moment when they become the practicable state in output device 10 that is designated as an output destination as stated above, it is possible to change the output destination by internal data processing for the job data held in output control server 30, provided that the change of the output destination is made before the start of the transfer. Owing to this, it is not necessary for a user to conduct complicated operations to delete a job which has already been inputted in the output device and to input the job in the new output device, and it is possible to change the output destination through simple operations of drag & drop. Therefore, even in the case where the preceding job cannot be carried out on the output device designated first, because of a jam or a shortage of sheets, it is possible to move the job easily to another output device, and to confirm the output destination on the layout image, whereby, the job can be moved simply to the target output device, and output environment with high operationality and high user-friendliness can be provided to users.

Next, there will be explained operations for changing an output destination and output setting after the start of transfer of job data to the output device.

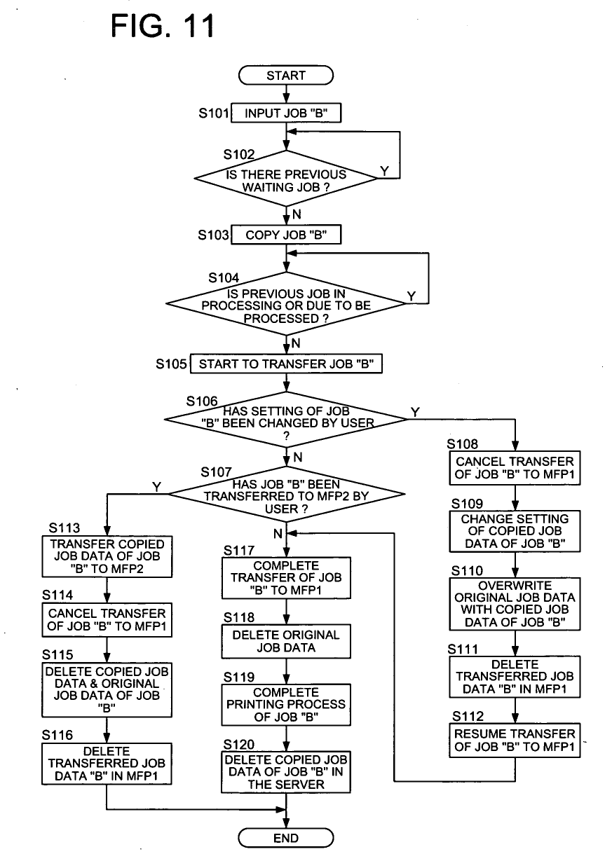

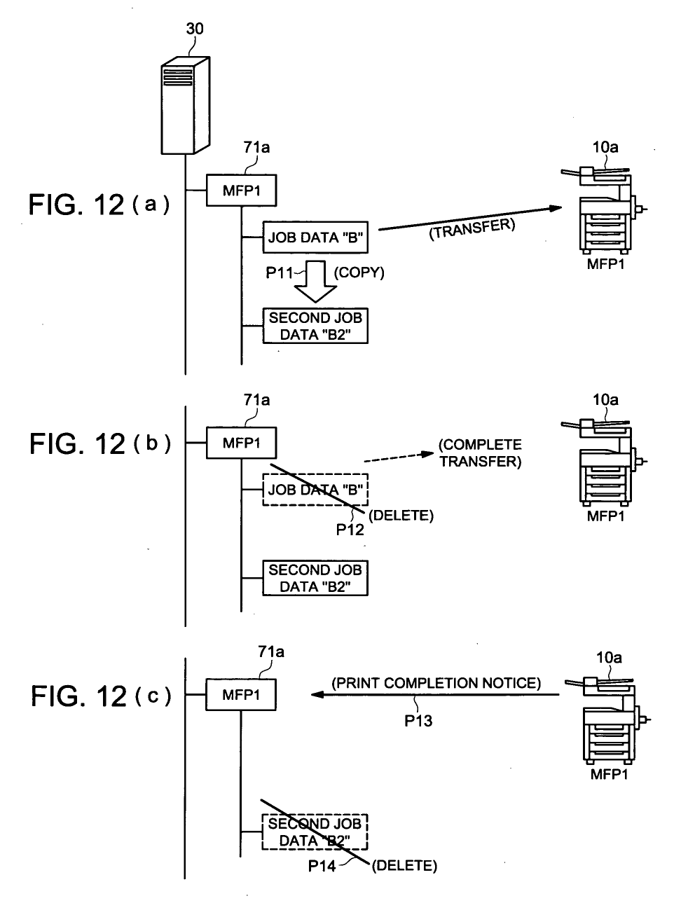

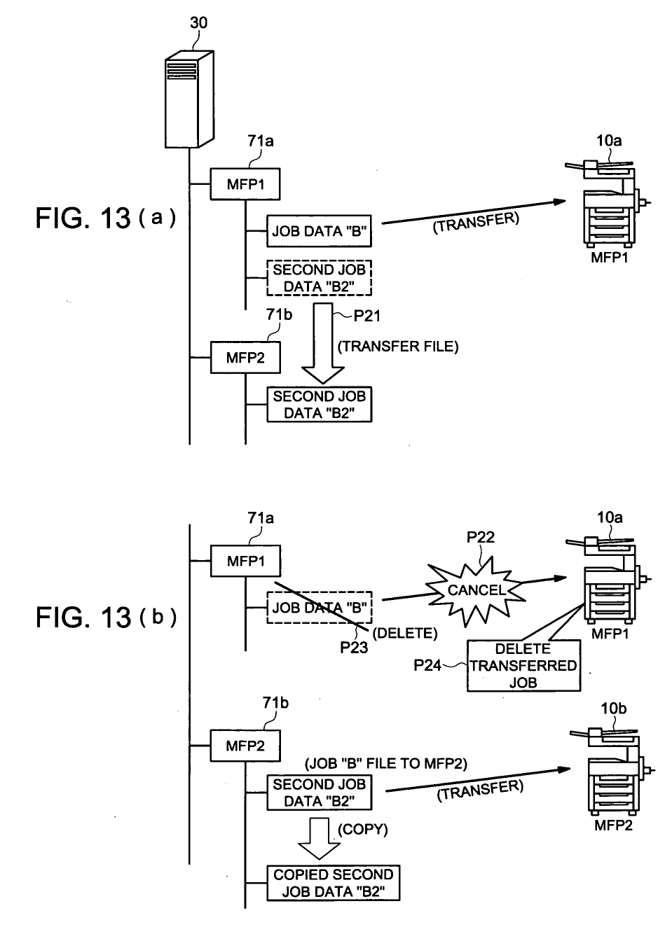

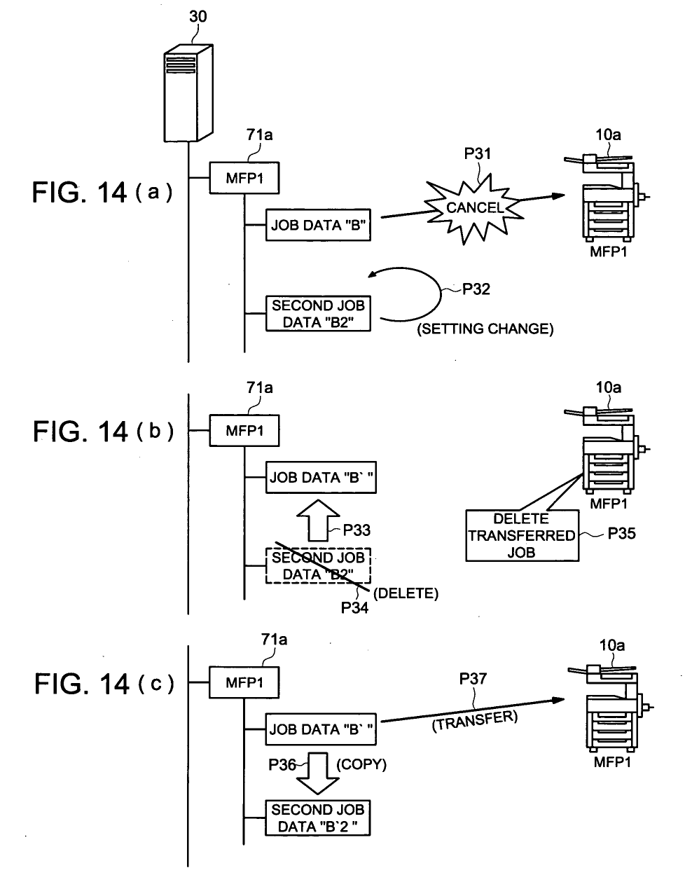

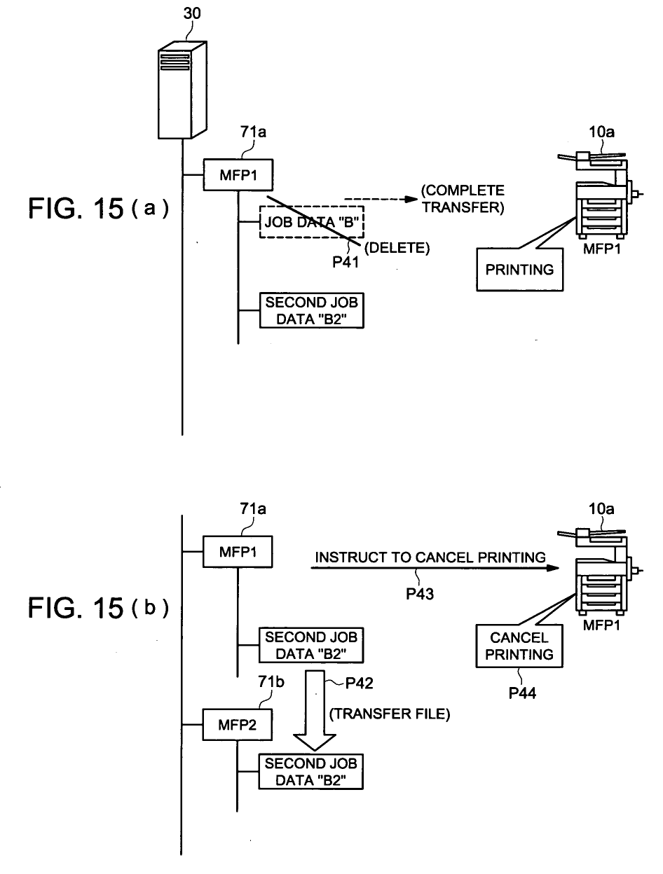

FIG. 11 is one showing a flow of processing conducted by control section A 31 of the output control server 30. FIG. 12 shows operations of the output control server 30 and the first output device 10a in ordinary operations in the case of completing printing in the output destination designated first. FIG. 13 shows operations in the case where manipulations to change an output destination of job B to the second output device 10b are made in the course of the transfer of the job data B to the first output device 10a. Further, FIG. 14 shows operations on the occasion where manipulations to change printing setting are made by a user for job B in the course of the transfer of the job data B to the first output device 10a. FIG. 15 shows operations in the case of receiving, from a user, the instruction to change an output destination, after completing normally the transfer of the job B to the first output device 10a. Incidentally, in each diagram of FIG. 12 and thereafter, display of job folder 72 is omitted, and the figure is made by simplifying so that job data look as if they exist under output destination folder 72.

After receiving, from information processing terminal 20, job data B of job B for which output device 10a is designated as an output destination, the output control server 30 files the job data B and preserves them in output destination folder 71a (step S101). Next, existence of a preceding job waiting for the transfer (standing by) to the first output device 10a is examined (step S102), and when the standby preceding job exists, it enters the state of waiting (step S102; Y), while, when the standby preceding job goes out of existence (step S102; N), second job data B2 representing a replication of job data B is made in the same output destination folder 71a as that for job data B (step S103, P11 in FIG. 12 (a)). After that, preceding job A is examined whether it is in processing or is supposed to be processed (step S104), and when the preceding job turns out neither to be in processing nor to be supposed to be processed (step S104; N), the transfer of job data B to the first output device 10a is started (step S105).

After this, when neither output setting nor output destination is changed by a user for job B in the course of transfer of job data B (step S106; N and step S107; N), original job data B in output control server 30 are deleted at a point in time when the job data B has been transferred completely to the first output device 10a as shown in FIG. 12 (b) (steps S117 and S118 in FIG. 11, P12 in FIG. 12 (b)). Further, as shown in FIG. 12 (c), when print processing for job data B is completed in the first output device 10a, a notice of termination of print processing is transmitted to output control server 30 from the first output device 10a (step S119 in FIG. 11, P13 in FIG. 12 (c)), and the output control server 30 that has received the notice of termination of print processing deletes the replicated second job data B2 (S120 in FIG. 11, P14 in FIG. 12 (c)), thus, a series of printing operations for job B are completed (end).

When a user changes the output destination for job B to the second output device 10b through drop & drag operations shown in FIG. 6, in the course of transfer of job data B to the first output device 10a (step S107 in FIG. 11: Y), this processing concerning the changing operations is conducted for the second job data B2 created by replicating job data B at the start of the transfer. Specifically, a file of the second job data B2 is moved from output destination folder 71a corresponding to the first output device 10a to output destination folder 71b corresponding to the second output device 10b (step S113 in FIG. 11, P21 in FIG. 13 (a)).

Next, output control server 30 cancels the transfer of job data B to the first output device 10a (step S114 in FIG. 11, P22 in FIG. 13 (b)). After that, original job data B in output destination folder 71a are deleted (step S115 in FIG. 11, P23 in FIG. 13 (b)). After deleting process in output control server 30 has been terminated, the first output device 10a deletes job data B transferred to the first output device 10a (step S116 in FIG. 11, P24 in FIG. 13 (b)). After that, there are conducted operations that the second job data B2 moved to output destination folder 71b are handled as job B in the second output device 10b, and they are replicated at the starting time for transfer to the second output device 10b.

When operations to change output setting for job B are carried out from a user in the course of transferring job data B to the first output device 10a (step S106; Y), processing concerning this operation for changing is conducted for the second job data B2 created by replicating the job data B at the start of the transfer. To be concrete, the transfer of job data B to the first output device 10a is canceled first (step S108 in FIG. 11, P31 in FIG. 14 (a)). After that, operations to change output setting for the second job data B2 replicated at the start of transfer are conducted (step S109 in FIG. 11, P32 in FIG. 14 (a)), and the second job data B2 after being changed are rewritten to job data B′ by overwriting original job data B with them (step S110 in FIG. 11, P33 in FIG. 14 (b)). After rewriting, the second job data B2 are deleted (P34).

After changing operations at the output control server 30 have been completed, the first output device 10a deletes job data B having been transferred to the first output device 10a, from the inside of the device (step S111 in FIG. 11, P35 in FIG. 14 (b)). After that, the output control server 30 creates second job data B′2 by replicating job data B′ after being rewritten (P36 in FIG. 14 (c), and starts the transfer of job data B′ to the first output device 10a (step S112 in FIG. 11, P37 in FIG. 14 (c)).

In the meantime, when an instruction for changing the output destination is received from a user after the transfer of job B to the first output device 10a has been completed normally, operations shown in FIG. 15 are conducted (the operations are not illustrated in FIG. 11). When the transfer of job data B to the first output device 10a is completed, the original job data B are deleted by the output control server 30 at that point in time (P41), but the replicated second job data B2 are kept in the output control server 30 even after completion of the transfer of original job data B.

Then, if a user conducts operations to change an output destination to the second output device 10b for job B in the course of print processing for job data B on the first output device 10a, the operations are conducted for the second job data B2. Specifically, the output control server 30 conducts processing to move the second job data B2 to output destination folder 71b (P42), and then, transmits a notice to cancel printing to the first output device 10a (P43). The first output device 10a that has received the notice discontinues printing, and then, cancels job data B (P44). The output control server 30 handles the second job data B2 moved to the output destination folder 71b as original data of job B in the second output device 10b, and starts the transfer of the second job data B2 to the second output device 10b. In this case, it operates to create its replications further, in the same way as in FIG. 13 (b).

As stated above, a replication of the job data is created at the point in time of the start of the transfer, then, original job data are used for the transfer to the output device 10, and operations for changing from a user conducted after the start of transfer, are conducted for the replicated second job data. Therefore, even in process of transfer of job data or in the standby state on the halfway of the transfer caused by troubles of an output device, it is possible to change output setting and to change an output destination for that job. Further, since the replicated second job data are not deleted even after completion of the transfer of original job data, and are kept until the moment of completion of print processing, output setting and an output destination can be changed until the moment of completion of print processing, even for the already transferred job.

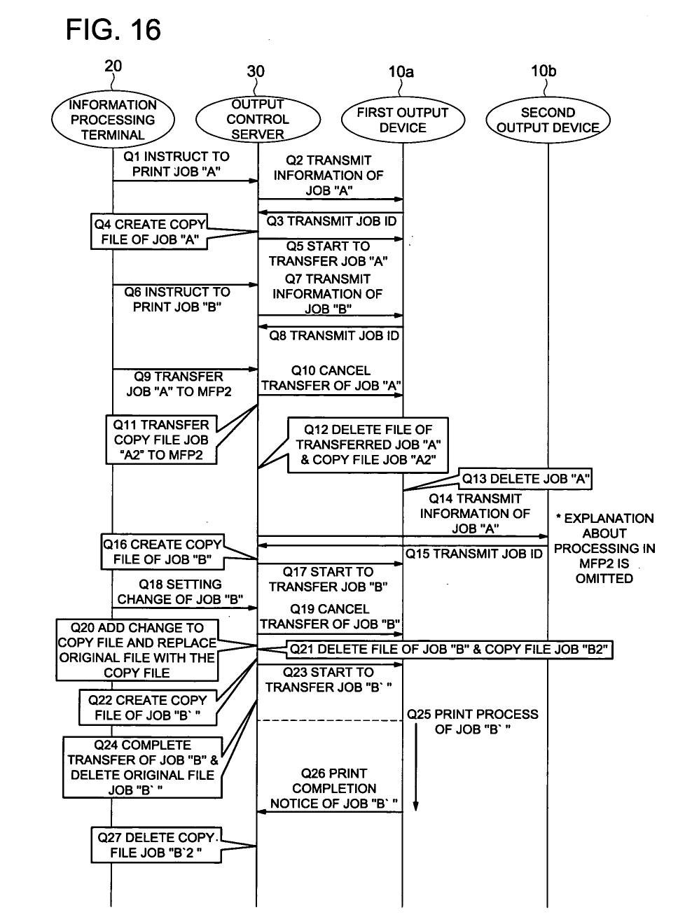

FIG. 16 shows data delivery and receipt sequence in data output system 5 in the case where the output destination of the job is changed or print setting is changed, after the job is sent from information processing terminal 20 to output control server 30. First, the information processing terminal 20 transmits job data A (image data, set information and IP address of an output destination device) relating to print instruction A coming from a user to output control server 30 (Q1). The job data A thus received are kept in the output control server 30.

The output control server 30 acquires a job type and an IP address of information processing terminal 20 of the sender from the received job-data A, and sends reservation job information (IP address and job type) to the first output device 10a designated as an output destination (Q2).

The first output device 10a which has received the reservation job information registers the job in an active job of functions corresponding to the job type (print, facsimile transmission and box storage), and sends the job ID of registration to the output control server 30 (Q3).

After that, in synchronization with timing when job A becomes practicable in the first output device 10a, the output control server 30 starts the transfer of job data A to the first output device 10a (Q5), and creates second job data A2 representing a replicated file of job data A in the same output destination folder 71a as that for original job data A, before the aforesaid start (Q4).

Thereafter, even for job B wherein the first output device 10b is designated as an output destination, print instruction B is sent to output control server 30 from information processing terminal 20 (Q6), the output control server 30 sends reservation job information B to the first output device 10a (Q7), and job ID of registration is sent back to the output control server 30 from the first output device 10a (Q8), in the same way as in the aforesaid Q1-Q3.

When an output destination changing instruction by which an output destination of job A is changed to the second output device 10b is sent by user's operations from information processing terminal 20 in the course of transferring job data A (Q9), the output control server 30 cancels the transfer of job data A to the first output device 10a, and notifies the cancel to the first output device 10a (Q10). Further, the output control server 30 moves the replicated second job data A2 held in output destination folder 71a corresponding to the first output device 10a to output destination folder 71b corresponding to the second output device 10b (Q11), and further deletes job data A and second job data A2 in the output destination folder 71a corresponding to the first output device 10a (Q12). In addition, in the first output device 10a, the transferred job data A are deleted by the notice of cancellation coming from the output control server 30 (Q13).

The output control server 30 sends reservation job information to the second output device 10b based on job data A moved to the output destination folder 71b (Q14), and receives job ID from the second output device 10b corresponding to the foregoing (Q15).

With deletion of job A, when job B becomes practicable on the first output device 10a, the output control server 30 starts transferring job data B to the first output device 10a (Q17), and creates second job data B2 representing the replicated file of the job data B in the same output destination folder 71a as that for original job data B, before the start of transfer (Q16).

When an output setting changing instruction for job B is transmitted by user's operations from information processing terminal 20 in the course of transferring job data B (Q18), the output control server 30 cancels the transfer of job data B to the first output device 10a (Q19). It further conducts processing to change output setting for the second job data B2, and overwrites the original job data B with the second job data B2 after the change to have job data B′ after the change (Q20). Due to this rewriting, job data B are deleted. Further, the second job data B2 after the change are deleted (Q21).

Second job data B′2 representing a replication of job data B′ after the change by rewriting is newly created (Q22), and the transfer of job data B′ after the change to the first output device 10a is started (Q23). The output control server 30 deletes job data B′ after completion of the transfer of the job data B′ (Q24). On the first output device 10a, print processing based on job data B′ is started (Q25), and when this print processing is completed, a notice of completion of printing is transmitted from the first output device 10a to the output control server 30 (Q26). After receiving the notice of completion of printing, the output control server 30 deletes replicated second job data B′2 (Q27).

Next, the second embodiment of the invention will be explained.

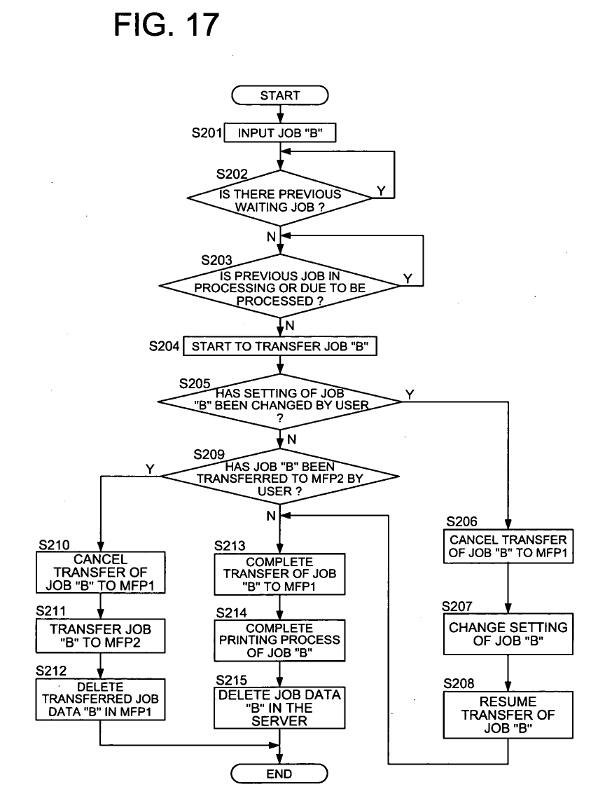

In the second embodiment, the processing is conducted without creating a replication of job data. FIG. 17 shows a flow of operations of output control server 30 in the second embodiment. A basic flow is the same as that shown in FIG. 11.

First, after an output instruction designating the first output device 10a as an output destination and job data B are received from information processing terminal 20, job data B are filed to be preserved in output destination folder 71a corresponding to the first output device 10a (step S201), and the transfer of the job data B to the first output device 10a is started (step S204) when the standby preceding job does not exist (step S202; N), and when the preceding job is neither supposed to be processed nor is in processing (step S203; N).

When operations to change output setting for job B are conducted from a user, in the course of transferring job data B (step S205; Y), the transfer of job data B to the first output device 10a is canceled (step S206), then the processing to change output setting is conducted for job data B (step S207), and job data B after the change are transferred to the first output device 10a (step S208). Then, when the transfer to the first output device 10a is terminated (step S213), and printing at the first output device 10a is completed (receiving a notice of completion of printing from the first output device 10a) (step S214), job data B held in output control server 30 are deleted (step S215), and the processing is terminated (end).

On the other hand, when an instruction to change the output destination to the second output device 10b is received in the course of transferring job data B to the first output device 10a (step S209; Y), the transfer of job data B to the first output device 10a is canceled (step S210), and job data B is moved to output destination folder 71b corresponding to the second output device 10b (step S211). In this case, the transferred job data B are deleted on the first output device 10a (step S212). Thus, the present processing is terminated (end), and after that, processing to transfer data to the second output device 10b is carried out, based on job data B moved to output destination folder 71b corresponding the second output device 10b.

In the case where operations to change an output destination or output setting for job B is not received from a user in the course of transferring job data B to the first output device 10a (step S209; N), when the transfer to the first output device 10a is terminated (step S213), and when printing on the first output device 10a is further completed (step S214), job data B held in output control server 30 are deleted (step S215), and the processing is terminated (end).

At the stage where the transfer of job data to output device 10 is completed, the job data are not deleted from the output control server 30 as stated above, and the job data are held in the output control server 30 until the moment when print processing is completed on output device 10. Therefore, even after completion of the transfer, changes in output destinations and in output setting can be made possible by the processing for the job data held in output control server 30. Accordingly, on the user side, it is possible to change output destinations and to change output setting for inputted job through simple operation such as drag & drop, without conducting operations to delete job once inputted and to send an instruction for printing wherein output destinations and output setting have been changed.

For example, it is possible to move easily the succeeding job to another output device, even in the case where the practice of a preceding job is prevented by jamming or a shortage of sheets in the output device designated first, and transfer of data for succeeding job becomes to be standby on the half way. It is further possible to move the job simply to the targeted output device because an output destination can be confirmed on layout images, and to provide output ambiance having high operationality and user-friendliness.

Embodiments of the invention have been explained above, and specific structures of the invention are not limited to the aforesaid embodiments, and modifications and additions which are not departing from the spirit and scope of the invention are also included in the invention.

For example, in the first embodiment, a replication of job data is created before the start of the transfer. However, the replication may also be created in the earlier stage than the foregoing, if that stage is earlier than the start of the transfer, or the replication may also be created simultaneously with preservation of the job data received from information processing terminal 20.

Further, the replication is not always needed for all of job data, and the replication for only the portion necessary for changing output destinations and output setting is acceptable. For example, a replication is not created for image data, and replication for only job information is allowed.

Further, in the embodiment, an arrangement is made so that an instruction for output of job and an instruction for changing output destinations may be given through drag & drop operations on layout images. However, operations on information processing terminal 20 are not limited to the foregoing, and operations to select the output destination from a list of names of devices, for example, are also allowed.

Further, with respect to the method to recognize completion of processing for the preceding job on output device 10, it is possible to predict, on the output control server side, the timing when a succeeding job becomes practicable on the output device 10 and to control the data transfer from output control server 30 to output device 10 based on the prediction, in addition to utilizing a notice (request for sending job information or the like) from the output device 10.

In the output control server and in the data output system relating to the invention, even in the course of transfer of job data from the output control server to the output device or even after completion of the transfer, it is possible to change the output destination and output setting of the job relating to the job data. Owing to this, a user can instruct the change of an output destination and output setting through simple operations, without inputting job again by conducting complicated setting, even in the case of changing the output destination and output setting for the job whose transfer has already started or the job whose transfer has already completed.

What is claimed is:

1. An output control server connected with an information processing terminal and with an output device through a network, the output control server comprising:
a communication section for receiving, from the information processing terminal, job data to be processed in the output device,
a memory for storing the job data received by the communication section and
a control section for controlling the job data as well as transmitting and receiving the job data,
wherein the control section conducts control to transfer the job data stored in the memory to the output device and deletes the job data from the memory when the transfer is completed and control to create second job data which are replications of the job data to store the second job data in the memory when transferring the job data.

2. The output control server of claim 1,
wherein the control section creates the second job data before a start of transfer of the job data.

3. The output control server of claim 2,
wherein the control section deletes the second job data stored in the memory when the output control server receives a notice of output completion of the job data from the output device.

4. The output control server of claim 1,
wherein the control section controls so as to transmit the job data to the output device when processing for the job data becomes practicable in the output device.

5. The output control server of claim 1,
wherein the control section conducts processing of changing a destination of the job data when the output control server receives, from an information processing terminal, an instruction of changing the destination of the job data stored in the memory.

6. The output control server of claim 1,
wherein the control section conducts processing of changing a destination for the second job data when the output control server receives an instruction of changing a destination for the job data while the job data are being transferred.

7. The output control server of claim 5,
wherein the control section stops transfer of the job data which are original job data of the replications and deletes the job data from the memory when the output control server conducts processing of changing a destination of the second job data.

8. The output control server of claim 1,
wherein the control section conducts changing processing of output setting of the job data when the output control server receives, from an information processing terminal, an instruction of changing output setting of the job data stored in the memory.

9. The output control server of claim 1,
wherein the control section conducts changing processing of output setting for the second job data when the output control server receives an instruction of changing output setting of the job data while the job data are being transferred to the output device.

10. The output control server of claim 8,
wherein the control section stops transfer of the job data which are original job data of the replications and deletes the job data from the memory when the output control server conducts processing of changing output setting of the second job data.

11. The output control server of claim 1, further comprising,
a display memory for storing display data to display information identifying a terminal corresponding to the output device and to display an operation screen so as to generate an output instruction of the job data based on user's drag and drop operations of information identifying data corresponding to the job data, to the information identifying a terminal,
wherein the control section transmits the display data to a display device of the information processing terminal.

12. The output control server of claim 11,
wherein the operation screen displays a layout image for showing a position of the output device and displays the information identifying a terminal, as an icon on the layout image.

13. A data output system in which an information processing terminal, a plurality of output devices and an output control server are connected through a network,
wherein the information processing terminal has a first communication section for transmitting job data to be processed in an output device of the plurality of output devices, to the output control server,
wherein the output device has a second communication section for transmitting a completion notice for the output processing to the output control server when output processing concerning the job data transferred from the output control server has been completed, and
wherein the output control server comprises:
a third communication section for receiving, from the information processing terminal, job data to be processed in the output device;
a memory storing the job data received by the third communication section; and
a control section for controlling the job data as well as transmitting and receiving the job data,
wherein the control section conducts control to transfer the job data stored in the memory to the output device, and to delete the job data from the memory when the transfer is completed and control to create second job data which are replications of the job data when transferring the job data, and to cause the second job data to be stored in the memory.

14. The data output system of claim 13,
wherein the control section creates the second job data before a start of transfer of the job data.

15. The data output system of claim 13,
wherein the control section deletes the second job data stored in the memory when the output control server receives a notice of output completion of the job data from the output device.

16. The data output system of claim 13,
wherein the control section controls so as to transmit the job data to the output device when processing for the job data becomes practicable in the output device.

17. The data output system of claim 13,
wherein the information processing terminal transmits, to the output control server, an instruction of changing a destination of the job data stored in the memory, and
wherein the control section conducts processing of changing a destination of the job data when the output control server receives, from an information processing terminal, an instruction of changing the destination of the job data stored in the memory.

18. The data output system of claim 13,
wherein the control section conducts processing of changing a destination for the second job data when the output control server receives an instruction of changing a destination for the job data while the job data are being transferred.

19. The data output system of claim 17,
wherein the control section stops transfer of the job data which are original job data of the replications and deletes the job data from the memory when the output control server conducts processing of changing a destination of the second job data.

20. The data output system of claim 13,
wherein the information processing terminal transmits from the first communication section, to the output control server, an instruction of changing output setting of the job data stored in the memory, and
wherein the control section conducts changing processing of output setting of the job data when the output control server receives, from an information processing terminal, an instruction of changing output setting of the job data stored in the memory.

21. The data output system of claim 13,
wherein the control section conducts changing processing of output setting for the second job data when the output control server receives an instruction of changing output setting of the job data while the job data are being transferred to the output device.

22. The data output system of claim 20,
wherein the control section stops transfer of the job data which are original job data of the replications and deletes the job data from the memory when the output control server conducts processing of changing output setting of the second job data.

23. The data output system of claim 13, further comprising,
a display memory for storing display data to display information identifying a terminal corresponding to the output device and to display an operation screen so as to generate an output instruction of the job data based on user's drag and drop operations of information identifying data corresponding to job data to be outputted, to information identifying a terminal, on a screen of the information processing terminal,
wherein the control section transmits the display data to a display device of the information processing terminal.

24. The data output system of claim 23,
wherein a layout image is displayed on a screen of the information processing terminal for showing a position of each of the plurality of output devices and the information identifying a terminal is displayed, as an icon on the layout image.

25. An output control server with which an information processing terminal and an output device are connected through a network, the output control server comprising:
a communication section for receiving, from the information processing terminal, job data to be processed in the output device;
a memory for storing the job data received by the communication section; and
a control section for controlling the job data as well as transmitting and receiving the job data,
wherein the control section controls to transfer the job data stored in the memory to the output device, and to store the job data in the memory until the moment when a notice of output completion is received from the output device, and to delete the job data from the memory when the notice of output completion is received from the output device.

26. The output control server of claim 25,
wherein the control section controls to change an output device to another output device for the job data and to transfer the job data to the another output device when the output control server receives, from the information processing terminal, a notice of changing the output device for the job data while the job data are stored in the memory.

27. The output control server of claim 25,
wherein the control section controls so as to transfer the job data to the output device when processing for the job data becomes practicable in the output device.

28. A data output system in which an information processing terminal, a plurality of output devices and an output control server are connected through a network,
wherein the information processing terminal comprises a first communication section for transmitting job data to be processed in an output device of the plurality of output devices to the output control server,
wherein the output control server comprises:
a third communication section for receiving the job data from the information processing terminal;
a memory for storing the job data received by the third communication section; and
a control section for controlling the job data as well as transmitting and receiving the job data,
wherein the control section controls to transfer the job data stored in the memory to the output device, and to store the job data in the memory until the moment when a notice of output completion is received from the output device, and to delete the job data from the memory when the notice of the output completion is received from the output device.

29. The data output system of claim 28,
wherein the control section controls to change an output device to another output device for the job data and to transfer the job data to the another output device when the output control server receives, from the information processing terminal, a notice of changing the output device for the job data while the job data are stored in the memory.

30. The data output system of claim 28,
wherein the control section controls so as to transfer the job data to the output device when processing for the job data becomes practicable in the output device.
